(19) United States
(12) Patent Application Publication
(10) Pub. No.: US 2003/0202368 A1
(43) Pub. Date: Oct. 30, 2003

(54) System and method for providing power factor correction

(76) Inventor: Paul Ierymenko, Lake Forest, CA (US)

Correspondence Address: PERKINS COIE LLP, PATENT-SEA, P.O. BOX 1247, SEATTLE, WA, 98111-1247, US

(21) Appl. No.: 10/133,725

(22) Filed: Apr. 26, 2002

(51) Int. Cl. H02M 7/00

(52) U.S. Cl. 363/125

(57) ABSTRACT

In one embodiment, a power factor correction (“PFC”) circuit is adapted to readily being retrofitted to existing power supplies, provided with new power supplies and/or integrated into new power supplies. The PFC circuit, unlike prior circuits, is connected in parallel with a power supply rectifier such as an AC-DC rectifier. In one embodiment the rectifier is a bridge rectifier with a rectifier-fed capacitive primary energy reservoir being used as an electrical power source. In one embodiment of the invention, the PFC circuit uses a boost converter governed by a control system to provide a cycle-completion, current-filling PFC mode above a prescribed average power threshold, and a continuous cycle PFC mode below the prescribed average power threshold.

### BACKGROUND

1. Technical Field

This invention relates to systems and methods for providing a power factor correction circuit.

2. Description of the Background

Market forces have created demand for improved electrical product performance and efficiency. One aspect of power efficiency and performance for any given electrical product is known as “Power Factor”. Power Factor is a measure the efficiency of electrical power used in an electrical device. One way to measure Power Factor is through the ratio of apparent power consumed by the electrical device (rms voltage times rms current) divided by the actual average power consumed by the electrical device. This ratio can never be greater than one, and is often considerably less. The energy lost due to low power factor is usually dissipated in the power distribution system as ohmic losses in the form of waste heat.

Many electrical products derive their electrical input from alternating current (“AC”) sources, such as connected to national electricity-providing grids. AC power sources by definition have time-varying voltage and current waveforms. One important source of diminished Power Factor is the existence of high frequency harmonics of the current above the primary current harmonic frequency. Another source of diminished Power Factor is the phase difference between the voltage and the current in the electrical device, for example, current lags behind voltage in many electrical devices. In either case, whether higher current harmonics exist or when current and voltage are out of phase and depending on the nature of the electrical device acting as a load, power factor is often decreased and energy is wasted. Industry has recognized the importance of Power Factor, thus, Power Factor Correction (“PFC”) circuits were created.

The goal of a PFC circuit is to increase the Power Factor of the electrical device receiving power. Many PFC circuits work to decrease higher frequency harmonics and/or to decrease the difference between the phases of the voltage and current in the electrical device. For example, PFC circuits for computers may focus more on the problem of higher frequency harmonics, while PFC circuits for motors may focus more on the problem of voltage/current phase difference. PFC circuits are often incorporated into a power source or placed between the AC line and the power supply which is often a AC-DC rectifying power supply that feeds the electrical device using the power. Unfortunately, such series connected PFC circuits necessarily carry the full power supplied to the electrical device and that requirement carries a significant cost. Furthermore, the PFC decreases the overall reliability of such a system because, if for no other reason, they are imperfect like any other device. When a PFC fails, it may cut power to the electrical device.

Many presently installed power supplies have no PFCs or have PFCs suffering from the deficiencies described above. Therefore, it would be desirable to have a system and method for providing power factor correction that mitigates or overcomes the above described aspects and other deleterious aspects of prior power factor correction circuits.

### BRIEF DESCRIPTION OF THE DRAWINGS

FIG. 1 is a high-level block diagram illustrating a power factor correction circuit working with other electrical devices in one embodiment of the invention.

FIG. 2 is a series of graphs illustrating electrical voltage or current versus time waveforms of the embodiment of FIG. 1.

FIG. 3 is a detailed circuit diagram of the embodiment of FIG. 1.

FIG. 4 is a detailed circuit diagram of a modulator portion of the power factor correction circuit of the embodiment of FIG. 1.

In the drawings, the same reference numbers identify identical or substantially similar elements or acts. Note that the headings provided herein are for convenience and do not necessarily affect the scope or interpretation of the invention.

### DETAILED DESCRIPTION OF THE EMBODIMENTS

The invention will now be described with respect to various embodiments.

The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention. For each embodiment, the same reference numbers and acronyms identify elements or acts with the same or similar functionality for ease of understanding and convenience.

The problems and disadvantages described above are overcome by embodiments of the invention, which in at least one embodiment provides a novel power factor correction (“PFC”) circuit adapted to readily being retrofitted to existing power supplies, provided with new power supplies and/or integrated into new power supplies. The PFC circuit, unlike prior circuits, is connected in parallel with a AC-DC rectifier, such as a bridge rectifier with a rectifier-fed capacitive primary energy reservoir being used by the rest of the system as an electrical DC power source. In one embodiment of the invention, the PFC circuit uses a boost converter governed by a control system to provide a cycle-completion, current-filling PFC mode above a prescribed average power threshold, and a continuous cycle PFC mode below the prescribed average power threshold. In one embodiment of the invention, a switch or jumper is employed with the input rectifier to select between a standard voltage mode and a voltage-doubling mode to achieve international voltage compliance. Whether deployed together with a conventional non-PFC off-line power supply as a retrofittable module, provided with a new power supply or as an integrated power supply system, the PFC circuit provides a significant improvement in efficiency, power factor and dynamic headroom as described herein. In one embodiment the PFC circuit works with a variable power consumption apparatus, such as an audio power amplifier, and satisfies European harmonic content regulations EN 61000-3-2, hereby incorporated by reference.

In a variable power consumption system such as an audio power amplifier, a boost converter circuit is deployed in parallel with a diode/capacitor rectifying input stage of the amplifier's conventional off-line power supply. The subsystem freely switches between two modes. The first mode is activated at any load power below a prescribed threshold power consumption, whereupon said boost converter draws a nearly sinusoidal current from the AC line and maintains the primary reservoir capacitor of the host system at a prescribed and regulated voltage above the AC line peak voltage. The second mode is activated whenever the variable consumption system demands load power in excess of said threshold power for longer than a time determined by the size of a reservoir capacitor, whereupon the load current exceeds the current provided by the boost converter causing the DC voltage on the reservoir capacitor to fall out of regulation down to the peak voltage of the AC line allowing the existing parallel off-line rectifier of the host system to supply a first peak current while the subsystem of the invention supplies a second skirt current that flows during those portions of an AC cycle when the rectifying input stage is not conducting current. When the first and second currents combine in the AC line, the resulting composite current improves the power factor and approximately tracks the sinusoidal line voltage waveform. When used in a system that activates a voltage doubler connection to support worldwide AC line voltage compatibility, said first and second modes of operation are automatically modified to provide approximately the same load power. Thus the invention provides a variable consumption system with good overall power factor correction without having to pass the highest variable system currents through the PFC circuit.

In one embodiment the PFC circuit is a modular design capable of being connected to existing power supplies without breaking any connections in the existing power supply. Because the PFC circuit is connected in parallel with the power supply rectifier it does not have to transmit 100% of the power and therefore can use less expensive parts having lower power handling capability than the system as a whole. A further benefit is that the add-on stage is fused so that its failure allows the overall system to continue to function in its original non-PFC mode. The invention may be deployed in parallel with any conventional rectification stage that employs rectifiers that feed a storage capacitor, whether this stage occurs immediately at the AC line input to the system or after the secondary windings of a conventional AC power transformer. Thus the invention can improve the power factor of many existing switched mode power supply (“SMPS”) systems and also of simple transformer-coupled linear power supplies. The parallel connection also shows improved efficiency relative to two stage PFC systems because the peak currents do not flow through the PFC circuit.

Embodiments of the present invention reduce the system cost of a variable consumption system by providing two modes of power factor correction. Below a prescribed power consumption threshold, the line current through the filtered boost converter of the invention is continuous over the AC line voltage cycle and closely tracks the instantaneous AC line voltage, thus providing good power factor correction. Above said threshold power the line cycle current through said boost converter becomes discontinuous, being zero during the peaks of the AC line voltage cycle and being proportional to the instantaneous AC line voltage during non-peak portions of the line voltage waveform. Thus, peak power in excess of the prescribed threshold is supplied by peak currents that flow directly through the host input rectifier, bypassing the PFC circuit. Therefore the power handling components of the subsystem must handle only a fraction of the current and thus can be smaller and less expensive. This attribute makes it a less expensive solution for correcting power factor than prior PFCs and makes it particularly applicable to systems where failsafe behavior is of paramount importance.

Embodiments of the present invention safely and beneficially handle the condition of very low or zero load power that may occur in variable consumption systems. When load current approaches zero, conventional power factor correction circuits may raise the boost storage capacitor voltage beyond the rating of the capacitor. If overvoltage protection is a feature of the conventional circuit, it may still raise the system voltage to the highest allowed voltage while the system is idling, and this voltage stress can shorten the lifetime of the system. Some embodiments of the present invention overcome this problem by monitoring the magnitude of ripple on the primary reservoir capacitor to sense load current demand. The ripple amplitude is a direct function of load current through the relation dv/dt=i/c. When demand is below a threshold current, the PFC boost action is disabled. Thus the voltage stress upon the primary reservoir capacitor and other system components is reduced when the system is idle or operating at very low power. As soon as sufficient demand is sensed, the PFC circuit is enabled.

Regarding headroom, in an audio power amplifier, the magnitude of undistorted output signal is constrained by the voltage available on the supply voltage rails, and voltage rail ripple reduces the attainable undistorted voltage swing of the amplifier. Because embodiments of the invention act to reduce ripple amplitude and to boost the DC rail voltage to a regulated high voltage when power consumption is below a prescribed threshold, a power amplifier fitted with an embodiment of the present invention is able to deliver higher short-term peak power to its load. This increased short-term power, known otherwise as the “music power” is a sought-after attribute of an audio power amplifier. At many load impedances but particularly above 4 ohms, dynamic headroom is greatly improved because the embodiments of the present invention take advantage of lulls in the music to pump up the voltage on the reservoir capacitor so that subsequent music peaks can be expressed with greater energy.

At power levels above a prescribed threshold power, some embodiments of the present invention do not pass current during those portions of time that the AC line is at its peak voltages. At those instances, current flows as it did before the invention was connected. The highest power transfer is therefore made at the same efficiency as before the PFC was connected. During the remaining time intervals, the PFC supplies current to a capacitor input reservoir from the lower voltage skirts of the AC line sinusoidal voltage waveform. It does so with efficiency common to conventional non-isolated boost mode PFC circuits. Thus the overall power supply efficiency is always better than that of a system consisting of a PFC stage and a DC-DC converter stage arranged serially, all other factors being equal.

Embodiments of the present invention improve the power factor of non-PFC power supplies. Most conventional transformer-isolated power supplies have secondary windings that pass current through a rectifier and store energy in a capacitive reservoir at a voltage roughly corresponding to the peak voltage of the AC line as translated through the transformer turns ratio. These historically popular and very reliable non-switching power supplies have input current characteristics very similar to diode-capacitor fed switching DC-to-DC converters. The invention can be used on the secondary side of a power transformer as easily as on the primary side to improve the power factor of heritage passive transformer isolated power supplies. Millions of such supplies are still in service, and virtually all have poor power factor.

Previously, manufacturers faced the costly task of redesigning existing products' power supplies to meet recently revised European harmonic current standards. Embodiments of the present invention enable the correction of products to meet the new European standards by adding a modular circuit to the existing power supply. Since a single module design can be deployed in a variety of products, this offers a way to greatly reduce the engineering costs of complying with these regulations.

In a fixed consumption system, embodiments of the present invention provide several benefits, dependent upon the values prescribed for the power and reservoir voltage regulation thresholds. For example, in one embodiment of the present invention, the subsystem of the invention could be “dialed in” to provide useful power factor correction while conducting only skirt currents, thus keeping its cost to a minimum. Some embodiments maintain a minimum reservoir voltage during low-line conditions. Some embodiments allow the input line to be switched between a standard AC line and 24 or 48 volts DC. Such embodiments of the present invention provide existing conventional systems with the capability of operating at limited power levels under simple battery fed emergency power, or in circumstances such as in mobile systems when normal AC line voltages are unavailable.

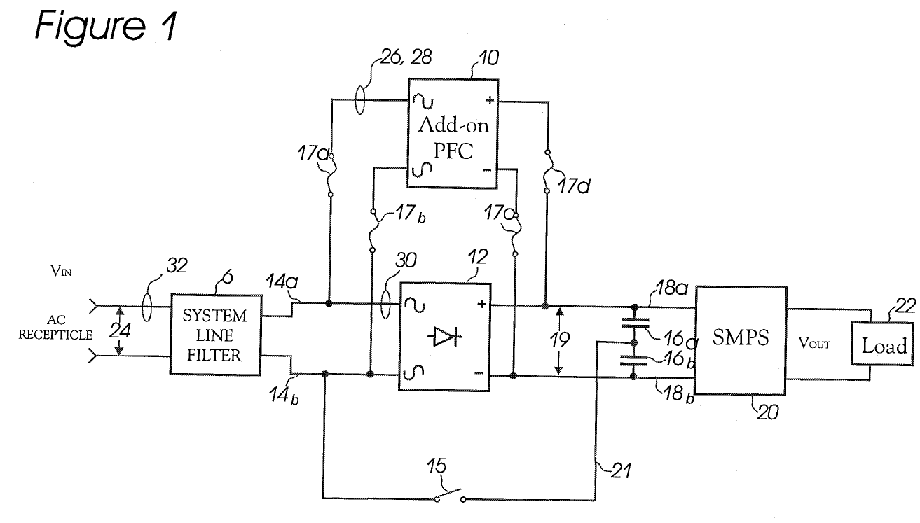

Turning to FIG. 1, there is shown a high-level block diagram illustrating a PFC circuit 10 working with other electrical devices in one embodiment of the invention. The PFC circuit 10 may be added onto an existing power supply, or deployed with or integrated into a new power supply. In one embodiment, the PFC circuit 10 is connected in parallel with an existing power bridge rectifier 12 of an off-line power supply input stage 12 through fuses 17a-d as shown. The rectifier 12 has line outputs 18a and 18b connected to switched mode power supply (“SMPS”) 20. When in operation, a voltage 19 exists between line outputs 18a and 18b. SMPS 20 is an optional isolating DC-to-DC converter shown to illustrate a typical complete system used as a final stage to provide electrical power to a load 22. In an alternative embodiment, the load 22 is connected directly between lines 18a and 18b for direct, non-isolated off-line operation. Capacitors 16a and 16b are connected in series between lines 18a and 18b, respectively. If no voltage doubling switch or jumper is present, capacitors 16a and b could be replaced by a single capacitor 16. A system line filter 6 for filtering electromagnetic interference (known as “EMI”) is used in one embodiment to reduce common mode, differential mode, and radiated switching noise, but such a filter will usually be already present in a host switching power supply and is not essential for operation of the invention, though it may be used to meet RF emission restrictions. The system line filter 6 receives electrical power from an AC receptacle having an alternating voltage waveform 24. The system line filter 6 is connected to the input waveform 24 and lines 14a and 14b, which are connected to the rectifier 12 and the PFC circuit 10. The system line filter 6 filters high frequencies from being returned to the power line. A voltage doubling switch 15 is connected to line 14b at one end and between capacitor 16a and capacitor 16b at the other end. If switch 15 is closed, the system functions in voltage doubling mode. The effective AC line voltage is doubled when the switch 15 is in one position and of normal values when the switch 15 is in the other position, so that voltage 19 can be made substantially the same whether the AC line is 120 volts or 240 volts, to support international operation.

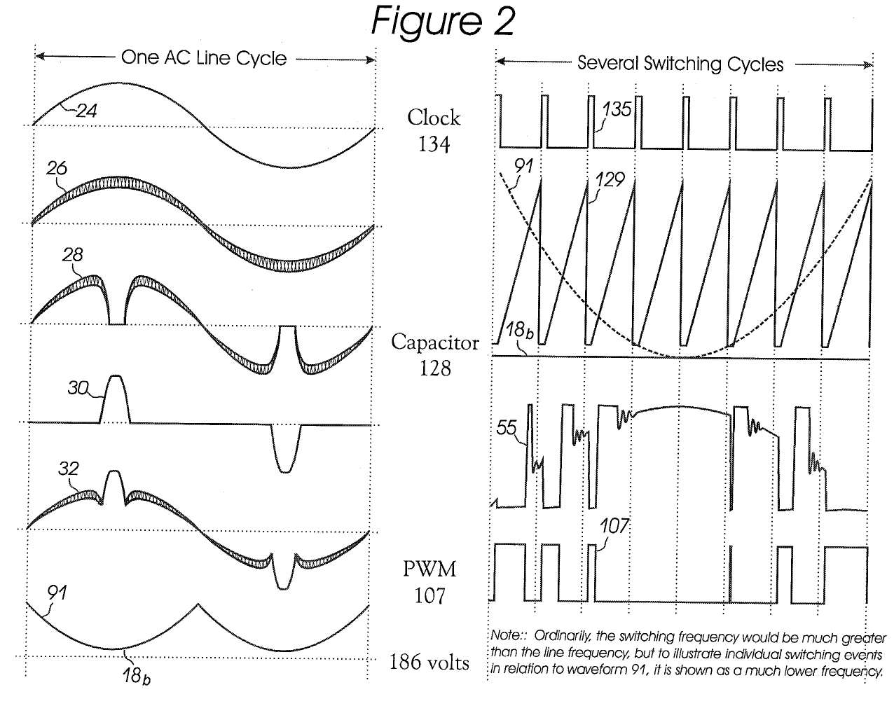

In operation, voltage and current pass through the line filter 6, the rectifier 12 and PFC circuit 10, the SMPS 20 and finally to the load 22. Referring to FIGS. 1 and 2, an AC line cycle current 32 is measured at the AC receptacle illustrated in FIG. 1 and the corresponding current waveform is shown in FIG. 2. Note that waveforms 26, 28, 30 and 32 in FIG. 2 are presented in terms of current versus time and waveforms 24, 91, 135, 129, 18b, 55 and 107 are presented in terms of voltage versus time. Note also that on the figures a current measurement is indicated by a circle surrounding the wire carrying the current. If the electrical current reaching load 22 is below a prescribed threshold and the voltage 19 is higher than the peak AC line voltage, then the bridge rectifier 12 does not conduct and PFC circuit 10 delivers all current to load 22 instead of the rectifier 12. An improved power factor is obtained and in this case switching current waveform 26 resembles line voltage waveform 24, referring to FIG. 2. Note that by way of example, one advantageous setting of the prescribed current in an audio amplifier would be to set it equal to the average load current specified for that device.

When current provided to the load 22 is above the prescribed threshold, the voltage on capacitors 16a and 16b is depleted down to the peak voltage of the AC line and bridge rectifier 12 conducts at the peaks of the AC line voltage, producing current waveform 30 in bridge 12. During those portions of an AC cycle when bridge 12 is not conducting, PFC circuit 10 draws current from AC lines 14a, 14b and delivers it to reservoir capacitors 16a, 16b, thus providing a shaping or filling current 28 that continues to improve the power factor. Note that there may be a short transition region where both circuit 10 and rectifier 12 conduct current to reservoir 16, but this is incidental to the general concept of the invention. In this mode, current 28 and current 30 add together in lines 14a and 14b to produce composite line current 32 in FIG. 2. Capacitors 16a and 16b are relatively large and do not discharge by a large amount relative to the charge they contain in normal operation, thus their voltage can be viewed as fairly constant.

The PFC circuit is connected in parallel with the rectifier 12 such that if it were to fail creating a short circuit it would blow one or more fuses 17a-d creating an open circuit condition in place of PFC circuit 10 and effectively taking PFC circuit 10 out of the system. If the PFC circuit failed as an open circuit, the effect would be the same. In either case, failure of the PFC circuit will not affect connected components, which can continue without the PFC circuit. This provides a more fault-tolerant solution to supplying electrical power which can be important in a number of circumstances, such as live public performances using audio amplifiers. If the PFC circuit 10 were to fail, reservoir capacitors 16a-16b will still be supplied current through bridge rectifier 12 and the load will continue to receive power and to function. In an alternative embodiment, one or more of the fuses are omitted with only a small decrease in reliability.

In voltage doubling mode, it is conceivable for circuit 10 to pump unequal voltages on to capacitors 16a and 16b due to a mismatch between the capacitors 16a-16b and/or other circuitry. In an alternative embodiment, PFC circuit 10 has an additional input connected to line 21 to provide an indication of voltage on line 21. Line 21 provides the voltage information to the PFC circuit 10 to dynamically equalize the voltages of capacitors 16a and 16b. The voltages across capacitors 16a and 16b is subtracted to yield a difference term representing the amount of voltage imbalance. The difference term would be gated by the AC line polarity and applied to a modulator as an auxiliary error term to adjust a pulse width modulated (“PWM”) signal in the direction of balance. This allows the PFC circuit 10 to compensate for and balance the voltages on capacitors 16a and 16b.

In another alternative embodiment, PFC circuit 10 may have an indicator output to alert the user that power factor correction is engaged, or it may have an external clock input to synchronize its switching frequency to that of the host system.

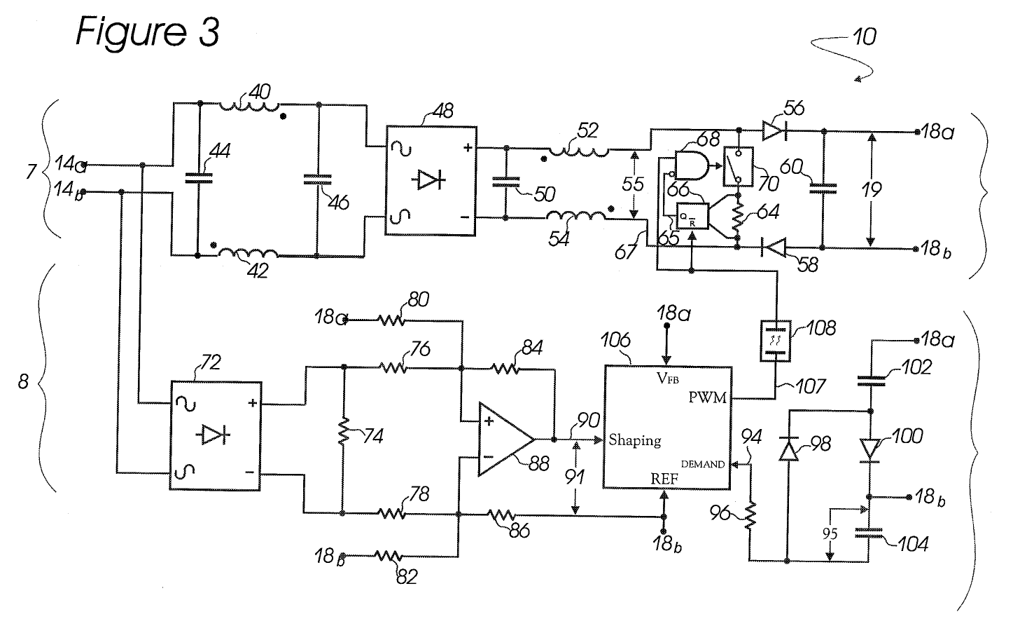

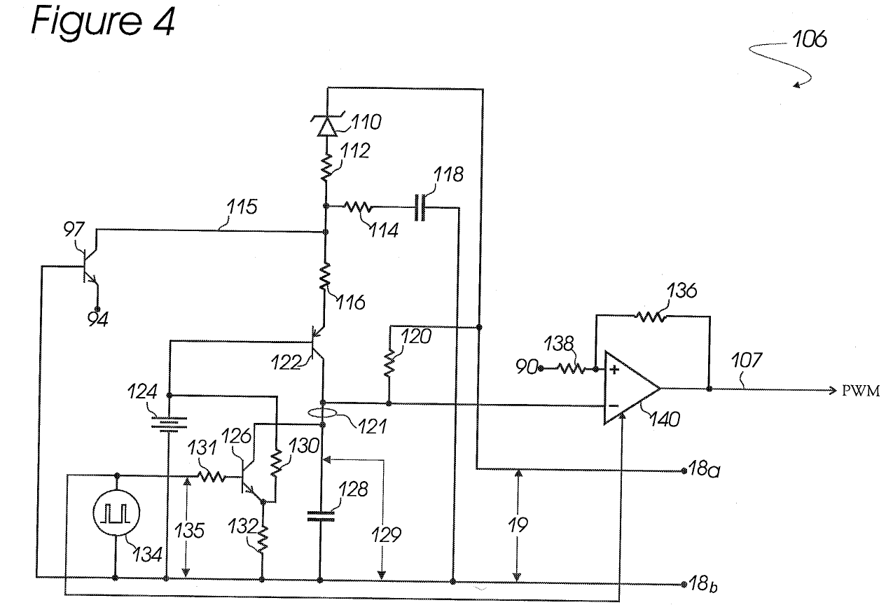

Referring again to FIG. 2, waveforms not described above will be described below in conjunction with FIGS. 3 and 4. Turning now to FIG. 3, there is shown a detailed circuit diagram of the embodiment of FIG. 1. The PFC circuit 10 contains a symmetrical boost converter 7. The symmetrical boost converter 7 supplies current to the load as shown in FIG. 2, waveform 26 or 28 depending on the operating mode. The symmetrical boost converter 7 receives current from lines 14a and 14b and provides current to lines 18a and 18b, as shown in FIG. 1. Line 14a is connected to inductor 40 and line 14b is connected to inductor 42. Capacitor 44 is connected between lines 14a and 14b. Capacitor 46 is connected between inductor 40 and inductor 42 as shown to provide differential mode filtering. Inductors 40 and 42 and capacitors 44 and 46 provide differential filtering which integrates the current pulses drawn by boost converter 7 into a smooth current drawn from inputs 14a and 14b. Inductors 40 and 42 are connected to a bridge rectifier 48. The DC outputs of bridge rectifier 48 are connected to capacitor 50 that provides additional pulse filtering and feeds boost inductors 52 and 54 as shown. A switching voltage waveform 55 is described herein between boost inductor 52 and boost inductor 54. Inductor 52 is connected to switch 70 and diode 56 as shown. Diode 56 is connected to capacitor 60 and line 18a. Switch 70 can be a MOSFET, IGBT, or other switching device. Switch 70 when closed connects boost inductors 52 and 54 together through current-sensing resistor 64. Connected to resistor 64 is diode 58. Capacitor 60 is connected between diode 58 and diode 56. A voltage 19 is described herein between lines 18a and 18b.

An AND gate 68 controls switch 70. The AND gate 68 receives inverted output from latch 66. Latch 66 and AND gate 68 receive pulse width modulation (“PWM”) signals from optocoupler 108, which electrically isolates the boost converter from modulator 106. When AND gate 68 causes switch 70 to close, the switch 70 completes a circuit including boost inductors 52 and 54, which are connected in series, thereby causing an increasing current to flow as boost inductors 52 and 54 charge. Resistor 64 is for current sensing purposes and does not materially impede the current flow. Latch 66 is connected to and senses the voltage drop across resistor 64. As shown in FIG. 2, when switch 70 opens, voltage 55 rises almost instantly to the point where diodes 56 and 58 conduct, and inductors 56 and 58 discharge through diodes 56 and 58 into local storage capacitor 60, feeding current through lines 18a and 18b and charging host reservoir capacitor 16.

In an alternative embodiment inductor 54 and diode 58 may be replaced by shorts and the circuit will still function, but not in doubler mode. This simpler configuration may be used at one nominally fixed AC line voltage. Note that inductor 54 may be retained, but wound on the same core as inductor 52 in the direction shown by the dots to form a composite inductor. Where a universal voltage scheme employing the doubler configuration is used, inductors 52 and 54 are separate and matched, and diode 58 is present.

The series combination of the switch 70 with inductors 52 and 54 is such that the diode recovery current is limited by one or the other of the inductors 52, 54, allowing the power switch 70 to fully close even during diode recovery, thereby reducing switch losses. In normal operation, both inductor 56 and inductor 58 are not in continuous current boost mode at the same time.

In yet another alternative embodiment, inductor 42 can be omitted or wound on the same core as inductor 40 in the direction shown. This option reduces parts count, but provides only differential filtering and no common-mode filtering. Separate inductors provide both differential and common mode filtering, but since such filtering may already be present in the host system, it need not always be duplicated in the PFC circuit.

Continuing with FIG. 3, shown below the boost converter 7 is the modulation circuit 8, which includes modulator 106. The modulation circuit 8 contains a low power bridge rectifier 72 that receives an AC voltage through lines 14a and 14b and transmits a rectified DC voltage to resistors 76 and 78 as shown. Resistor 74 is connected between resistors 76 and 78. A differential op-amp 88 is connected to the resistors 76 and 78 as shown. Line 18a is connected to the negative input of op-amp 88 through resistor 80. Line 18b is connected through resistor 82 to the positive input of op-amp 88. Resistor 80 is connected to resistor 76 and resistor 78 is connected to resistor 82, which are both connected to line 18b through resistor 86. The op-amp 88 has output line 90 from which a voltage 91 is measured with regard to FIG. 2. The op-amp 88 has output line 90 driving a shaping input on modulator 106. The op-amp 90 output is fed back through resistor 84 to a negative differential input on the op-amp 88. The op-amp 88 output 90 is driven to a shaping input on modulator 106. The modulator 106 is also connected to line 18a at a VFB input and line 18b at a REF input. The modulator 106 is connected to resistor 96 at a DEMAND input. The modulator 106 produces a pulse width modulation (“PWM”) signal at a PWM output 107. Then PWM signal is transmitted to the optocoupler 108 which effectively isolates the signal from the different voltage reference frames and transmits the signal on a separate voltage to latch 66 and AND gate 68 to control the boost converter 7 as described herein. The resistor 96 is coupled to lines 18a and 18b through diodes 98 and 100 and capacitors 102 and 104 as shown in FIG. 3

The modulation circuit 8 presents a novel way to provide control signals to boost circuit 7. Bridge rectifier 72 provides a low-current full-wave rectified line voltage signal that is subtracted from voltage 19 (on lines 18a and 18b), by a differential circuit including resistors 76, 78, 80, 82, 84, and 86 and operational amplifier 88. The resulting voltage waveform 91, shown in FIG. 2, is referenced to line 18b, which is also the reference point for modulator 106. Resistor 74 provides a better load for bridge 72 and improves waveform fidelity. As waveform 91 of FIG. 2 illustrates, voltage 91 is the absolute value of the AC line subtracted from the DC output of the boost circuit and scaled to a range suitable to modulator 106. Therefore, the troughs of the waveform approach reference line voltage 18b when the AC line peaks equal or exceed voltage 19, which is the particular case illustrated on the right side of FIG. 2 where 91 is shown superposed upon waveform 129. Whenever voltage 19 is higher than the peak AC line voltage 24 of FIG. 1, waveform 91 “floats” above the reference by that amount in proportion to the scaling. When switch 15 of FIG. 1 is closed and the input rectifier circuit 30 operates in a voltage-doubling mode, voltage 19 will always be higher than the peak of voltage 24, so waveform 91 will not usually dip below the ramp 129 or intersect 18b, as is shown on the bottom left of FIG. 2. This increases the duty cycle of the PWM to compensate for the relatively lower AC voltage.

Within modulator 106, voltage waveform 91 modulates a sawtooth-type carrier to produce the PWM signal on PWM output 107 that, when applied to the boost converter, produces a line current waveform sufficiently similar in phase and shape to the AC line voltage waveform to meet harmonic current criteria. This is achieved without closed-loop current control. Embodiments of the present invention use input current shaping in an open-loop manner by modulating the switch pulse width by the inverted absolute value of the line voltage. In addition to voltage 91 providing a current-shaping function, voltage 91 allows the PFC circuit 10 to achieve other beneficial results. For example, the trough of waveform 91 approaches the reference 18b when AC line voltage 24 exceeds voltage 19, which is also when host bridge rectifier 12 is about to take over and shunt direct peak current to reservoir 16. The modulator exploits this property and stops the PWM signal for as long as voltage 19 is below a small threshold relative to the reference 18b. This increases the efficiency of the system by temporarily removing PFC-related losses from the overall loss budget during peak current intervals when host bridge rectifier 12 is conducting and driving current to the load 22. Waveform 28 of FIG. 2 shows the switching being interrupted at the peaks.

As shown in FIG. 3, the modulator reference point is connected to line 18b, which also corresponds to the more detailed illustration of the modulator 106 in FIG. 4. In this embodiment, the modulator is made with discrete components, however, in an alternative embodiment, the modulator is implemented in an integrated circuit which substitutes line 67 as shown in FIG. 3, the power switch circuit reference point, as identified in FIG. 3. In that case, optoisolator 108 is replaced with a conductor. Other signals used by the modulator 106 are transferred to this reference frame to allow all of the active circuitry required by the invention to operate within a range of approximately 15 volts, thus making an inexpensive IC based easy to implement. In yet another alternative embodiment, the IC implements the modulator in software and/or firmware. In another alternative embodiment, voltage 24 and voltage 19 are sensed separately using differential amplifiers and then combined arithmetically to produce voltage 91.

FIG. 3 also shows how the peak current flowing in power switch 70 is limited. Latch 66 has a voltage threshold that senses the voltage drop across current sensing resistor 64 caused by current flowing through the switch 70. When the switch current produces a voltage across sense resistor 64 sufficient to overcome the threshold of latch 66, a latched inhibit signal on line 65 commands switch-drive gate 68 to turn the switch 70 off. This truncates the instant PWM pulse from the optoisolator 108 and holds switch 70 off for the remainder of the switching cycle. When PWM signal 107 goes low, it clears and resets the latch in preparation for the next PWM cycle. The circuit thus forms a local binary feedback loop that limits the switch's 70 on time by truncating PWM signal 107, such that a prescribed maximum switch current is never exceeded. Limiting the switch current is useful because in a boost converter 7 the switch current increases strongly and non-linearly as the peak voltage 24 of the AC line closely approaches and then intersects the output voltage 19. Although waveform 91 acts to reduce and then suppress the PWM signal in the same region of operation, there are transitional regions of operation where current limiting is useful.

When the thresholds of the invention are properly set, the current limit will generally come into play only when the load power exceeds the power the PFC circuit 10 is able to deliver to the host. If the load 22 consumes less power than that threshold power, the AC line voltage peaks will not intersect output voltage 19 and the limiter will rarely be called upon to act. The current limiter improves the reliability of the circuit by almost instantly preventing potentially damaging currents from flowing in the power switch 70.

In operation, load current sensing operates by measuring the amplitude of the capacitor reservoir 16a, 16b voltage ripple. As reservoir capacitors 16a, 16b, are charged by lines 18a and 18b, and discharged by the load 22, the measured amplitude of its ripple voltage 19 is proportional to the load current. Referring to FIG. 3, capacitor 102 charges to the peak of voltage 19 through diode 100 and then, as the ripple voltage falls towards its trough, capacitor 102 pumps a voltage 95 representing the difference between the peak and the trough of voltage 19 through diode 98 onto capacitor 104. Resistor 96 converts voltage 95 to a current signal 94 suitable for modulator 106. Resistor 96 was also chosen to normalize current signal 94 with respect to the size of reservoir capacitors 16a, 16b. Modulator 106 uses signal 94 to speed up the modulator's control loop response to a rapid increase in current demand from the load 22. Signal 94 is also used to idle the PFC circuit 10 of the invention at some minimum load current such as may occur while the host system is in standby. This improves reliability by reducing voltage stresses while the system is idle or in standby mode. It should be noted that this method of load sensing measures load current without having to intercept and rewire the host circuit through a current sensing element, thereby making it easier to install a PFC circuit 10 into an existing variable consumption system such as an audio amplifier.

Turning to FIG. 4, there is shown a detailed circuit diagram of a modulator portion of the PFC circuit 10 of the embodiment of FIG. 1. An oscillator 134 produces the pulse stream shown in waveform 135 of FIG. 2. In one embodiment, the oscillator 134 puts out a 100 kHz square wave-type voltage waveform having a 10% duty cycle. The oscillator 135 is connected to line 18b and to the base of a transistor 126 through resistor 131. Note that the transistors described herein can be of any type capable of switching at the voltages and currents presented, such as bipolar transistors and metal oxide semiconductor field effect transistor (“MOSFET”) type transistors, and can be discrete components or part of one or more integrated circuits. The transistor 126 is connected at its collector to the collector of pnp transistor 122. The emitter output of transistor 126 is connected to line 18b via resistor 132 and to a voltage source represented by battery 124 through resistor 130. Note that the battery 124 can be replaced by circuitry providing similar DC characteristics and is shown as a battery for illustration purposes. Note that local power supplies for operational amplifier 88 and comparator 140 have been omitted for clarity. Such requirements are well known to anyone skilled in the art. The collector input of transistor 126 is connected to capacitor 128, across which voltage 129 in FIG. 2 is measured. Capacitor 128 is also connected to line 18b. Transistor 122 is connected to battery 124 in its base input and is connected to Zener diode 110 through resistor 116 and resistor 112. Zener diode 110 is connected to line 18a and resistor 120. Resistor 120 is connected to the emitter of transistor of 122 and provides for the minimum ramp rate associated with the modulator 106. Resistor 120 is connected to the negative input of differential op-amp 140. Differential op-amp 140 acts as a comparitor and has its positive input connected to line 90 through resistor 138. Feedback providing hysteresis is accomplished by connected op-amp 140 output 107, the PWM output, back to the positive input of the op-amp 140 through resistor 136. Op-amp 140 is enabled by, and connected to, clock 134. Resistor 114 is connected between resistor 112 and resistor 116 at one end and is connected to capacitor 118 at it other end. Capacitor 118 is also connected to line 18b. Transistor 97 is connected to resistors 112, 114 and 116 at its collector input. Transistor 97 has its emitter output connected to line 94 as shown in FIG. 3 and its base input to line 18b.

The oscillator 134, by periodically discharging capacitor 128 through transistor 126, forms a sawtooth-shaped signal 129 as the modulation carrier signal in FIG. 2. Resistors 130, 131, and 132 are arranged to set the lowest voltage of sawtooth 129 at a small threshold voltage above reference voltage 18b. Current 121 from transistor 122 charges capacitor 128 producing a ramp voltage, then capacitor 128 is quickly discharged by transistor 126, as waveform 129 indicates in FIG. 2. The slope of the ramp of the resulting sawtooth waveform is a function of current 121, which is an error current that increases as voltage 19 rises higher than Zener voltage reference diode 110. FIG. 2 illustrates this variable slope on one of the ramp 129 cycles. Comparator 140 changes state in response to the instantaneous difference between voltage 129 and voltage 91 on node 90 and produces a corresponding pulse-width modulated (PWM) switching signal. Resistors 138 and 136 provide a small amount of hysteresis around the comparator to prevent spurious transitions in PWM signal 107. The comparator is disabled during the positive pulse of oscillator 134 to blank out the discharge time from the PWM signal. Resistors 112, 114, 116 and capacitor 118 form the control loop filter and establish the response dynamics of the system to changes in capacitive reservoir voltage 19.

Load current signal 94 is steered through pass transistor 97 and applied to the loop filter at node 115 where it acts to speed up the response of the control loop to rapid increases in load current by diverting current from error current 121 and by discharging capacitor 118. The PWM output 107 of the modulator 106 represents the product of current shaping signal 90 and the ramp slope of sawtooth carrier signal 129. For a given value of signal 90, an increase in error current 121 produces a faster ramp and a narrower on-time PWM signal 107, and this acts to reduce the power supplied by the PFC add-on circuit 10 to host reservoir capacitors 16a, 16b by the boost converter 7. This establishes a negative feedback loop that acts to maintain a prescribed voltage 19 on reservoir capacitors 16a, 16b. Zener 110 prescribes the maximum voltage 19.

In the situation where the load power begins to exceed the maximum power that the PFC circuit 10 has been specified to provide, the troughs of voltage waveform 90 begin to fall below the minimum voltage of sawtooth carrier 129, so that comparator 140 never switches state and the PWM signal is suspended. This provides discontinuous “current-filling” behavior at load powers that exceed the predetermined threshold, as shown in FIG. 2. The frequency of the oscillator carrier would ordinarily be at least 1000 times that of the line frequency, but for purposes of clarity the oscillator time scale has been illustrated in FIG. 2 as though it was closer to the time scale of a portion of waveform 91.

As illustrated in FIG. 3, the optoisolator 108 transmits PWM signal 107 to the voltage reference frame of the booster converter 7. In the alternate integrated-circuit embodiment of the invention, optoisolator 108 is not needed. Instead, signals 90, 94 and 18a must be translated to the voltage reference frame of the integrated circuit using any suitable method of the many known methods, including optoisolation and differential re-referencing.

Thus there has been described a system and method for providing a power factor correction circuit. For example, the PFC circuit 10 can be retrofitted into existing equipment and/or manufactured into existing designs to add PFC to that equipment. Embodiments of the invention install into an otherwise unmodified non-PFC supply by wiring it directly in parallel with the existing rectification stage. Even though other PFC circuits exist, none are known to be amenable to the creation of an easily installed backwards-compatible PFC upgrade module that could serve to upgrade expensive existing systems that have poor power factor. In some embodiments of the present invention the PFC is implemented with an integrated circuit and/or in a digital signal processor (“DSP”).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform having steps in a different order. The teachings of the invention provided herein can be applied to other systems, not necessarily the system described herein. These and other changes can be made to the invention in light of the detailed description. The elements and acts of the various embodiments described above can be combined to provide further embodiments.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms. For example, while embodiments describe circuitry being fabricated in a semiconductor chip, other aspects may likewise be embodied in a chip. Accordingly, the inventors reserve the right to add additional claims after filing the application to pursue such additional claim forms for other aspects of the present invention.

I/we claim:

1. A power factor correction (“PFC”) circuit for improving power factor of an AC to DC converting (“AC-DC”) power supply, comprising:
a boost convertor, the boost convertor having a rectifier coupled to an AC receptacle having an alternating current waveform, the rectifier having substantially DC outputs connected to at least one inductor, said at least one inductor being charged and discharged in response to a switch having a plurality of switch positions; and
a modulation circuit, the modulation circuit including a modulator for providing a pulse width modulated signal to affect the position of the switch, wherein said power supply is an existing power supply and wherein the PFC circuit improves power factor of said existing power supply without breaking a wire in said existing power supply.

2. The PFC circuit of claim 1, wherein the PFC circuit is open-loop.

3. The PFC circuit of claim 1, wherein the PFC circuit improves the power factor of a variable power consumption load.

4. The PFC circuit of claim 3 wherein the variable power consumption load is an audio amplifier.

5. The PFC circuit of claim 1, wherein the PFC circuit is provided along with an existing AC-DC power supply.

6. The PFC circuit of claim 1, wherein the PFC circuit drives an output voltage that is not significantly greater than the peak input voltage.

7. The PFC circuit of claim 1, wherein the PFC circuit is not required to handle as much power as the AC-DC power supply.

8. The PFC circuit of claim 1, wherein the PFC circuit can fail without significantly affecting the AC-DC power supply.

9. The PFC circuit of claim 1, wherein a load current is inferred from the magnitude of a voltage ripple present on at least one capacitor connected between rectifier outputs.

10. A power factor correction (“PFC”) circuit for improving power factor of an AC to DC converting (“AC-DC”) power supply, comprising:
a switch, the switch having two positions for controlling current from the PFC circuit being delivered to a load; and
a modulation circuit, the modulation circuit including a modulator for providing a pulse width modulated signal to affect the position of the switch, wherein the PFC circuit improves power factor of said power supply without breaking a wire in said power supply.

11. The PFC circuit of claim 10, wherein the PFC circuit is open-loop.

12. The PFC circuit of claim 10, wherein the PFC circuit improves the power factor of a variable power consumption load.

13. The PFC circuit of claim 12 wherein the variable power consumption load is an audio amplifier.

14. The PFC circuit of claim 10, wherein the PFC circuit is provided along with an AC-DC power supply.

15. The PFC circuit of claim 10, wherein the PFC circuit drives an output voltage that is not significantly more positive than the peak input voltage.

16. The PFC circuit of claim 10, wherein the PFC circuit is not required to handle as much power as the AC-DC power supply.

17. The PFC circuit of claim 10, wherein the PFC circuit can fail without significantly affecting the AC-DC power supply.

18. The PFC circuit of claim 10, wherein a load current is inferred from the magnitude of a voltage ripple present on at least one capacitor connected between rectifier outputs.

19. A system for providing power factor correction (“PFC”) to an ACDC power supply, comprising:
a PFC circuit, the PFC circuit connected in parallel with a rectifying stage portion of said AC-DC power supply.

20. The system of claim 19, wherein the PFC circuit is open-loop.

21. The system of claim 19, wherein the PFC circuit is retrofittable into an existing power supply without breaking a wire in said power supply.

22. The system of claim 19, wherein the PFC circuit is provided with a new AC-DC power supply.

23. The system of claim 19, wherein the PFC circuit is integrated into a new AC-DC power supply.

24. The system of claim 19, wherein the PFC circuit drives an output voltage that is not significantly more positive than the peak input voltage.

25. The system of claim 19, wherein the PFC circuit is not required to handle as much power as the AC-DC power supply.

26. The system of claim 19, wherein the PFC circuit can fail without significantly affecting the AC-DC power supply.

27. A power factor correction (“PFC”) circuit for improving power factor of an AC to DC converting (“AC-DC”) power supply, comprising:
boost converter means for transferring power during non-peak times of the AC-DC power supply, the boost converter means connected in parallel with a rectifying stage of said AC-DC power supply; and
modulation circuit means for controlling the boost converter means.

28. A method for improving power factor associated with an AC to DC converting (“AC-DC”) power supply, comprising:
boosting, with a power factor correction circuit, current supplied during off-peak current supply times of the AC-DC power supply; and
modulating the power factor correction circuit.

29. The method of claim 28 wherein a frequency of modulation from the modulation circuit need not be synchronous with an associated AC power line frequency.

30. A power factor correction (“PFC”) circuit for improving power factor of an AC power supply, comprising:
a PFC circuit connected in parallel with a rectifying stage of said AC power supply, wherein failure of the PFC circuit allows the AC power supply to continue to supply power to the load.

31. The PFC circuit of claim 30 wherein the failure of the PFC circuit acts like an open-circuit.

32. The PFC circuit of claim 30 wherein the PFC circuit is electrically coupled to the AC power supply by at least one fuse.

33. The PFC circuit of claim 30 wherein the PFC circuit is electrically coupled to the AC power supply by a plurality of fuses.

34. The system of claim 30, wherein a load current is inferred from the magnitude of a voltage ripple present on at least one capacitor connected between rectifier outputs.

35. A method for providing power factor correction (“PFC”) for improving power factor of a power supply, comprising:
improving power factor with a PFC circuit connected to the power supply in a first mode wherein the first mode includes load power consumption which is at or below a threshold and the PFC circuit improves power factor of the power supply substantially continuously during each AC cycle; and
improving power factor with the PFC circuit connected to the power supply in a second mode wherein the second mode includes load power consumption which is at or above the threshold and the PFC circuit improves power factor of the power supply by transferring power during non-peak times.

36. The method of claim 35, wherein a load current is inferred from the magnitude of a voltage ripple present on at least one capacitor connected between rectifier outputs.

37. A power factor correction (“PFC”) circuit for improving power factor of a power supply, comprising:
boost means for boosting effective output power of the power supply; and modulation means for controlling the boost means with a pulse width modulated signal, wherein the PFC circuit improves power factor in a variable power consumption load, wherein a load current is inferred by said modulation means from the magnitude of a voltage ripple present on at least one capacitor connected between rectifier outputs.

38. The PFC circuit of claim 37 wherein the variable power consumption load is an audio amplifier.
